(19) United States
(12) Patent Application Publication
(10) Pub. No.: US 2007/0156682 A1
(43) Pub. Date: Jul. 5, 2007

(54) Personalized user specific files for object recognition

(75) Inventors: David Andrew Howell, Seattle, WA (US); Clifford Neil Didcock, Sammamish, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/320,183

(22) Filed: Dec. 28, 2005

(51) Int. Cl. G06F 17/30

(52) U.S. Cl. 707/6

(57) ABSTRACT

A system for identifying an object corresponding to user input including a first grammar, a user specific file and a controller. The first grammar is a list of objects. The user specific file designates a subset of the list of objects in the first grammar which are related to the user. The controller receives the user input and compares the user input to the objects of at least the user specific file. The controller identifies to the user the object corresponding to the user input, giving preference to those objects designated in the user specific file.

### BACKGROUND

Computing devices translate input from a user into a form recognizable by the computing device. For example, a user presses a computer key to identify a specific alphanumeric character to the computing device. The keystroke is meaningless to a program running on the computer, but a corresponding object, a series of bits, is not. Similarly, computing devices today translate mouse input, speech, and other forms of user input into objects that they can use. In the case of mouse input, the user input identifies a particular program button or hyperlink to the computing device. In the case of speech the user attempts to identify a phrase or word to the computing system. Speech however, is not as precise or easily identifiable as a keystroke or mouse movement. The computing system must essentially guess at what object (e.g. phrase, word, name, sentence, etc.), the user is trying to identify to the system.

A speech recognition system compares spoken phrases to a list of possible phrases called a grammar. The system determines the probability that the spoken phrase is each phrase in the grammar. The phrase with the highest probability is selected as the spoken phrase by the system. The larger the grammar, the more likely it is that the grammar includes the phrase intended by the user, but the match is less accurate. Conversely, the smaller the grammar is, the more accurate the match will be, but the more likely it is that the intended phrase will not be in the grammar at all. For example, it is harder to locate an individuals name from a directory of 100,000 entries than from a directory of 1000 entries, and if the name is matched, the match from the smaller directory will be more accurate. However, there may not be a particular name in the smaller directory, and it is more likely that there is the particular name in a larger directory. As another example, a common name (e.g., Paul Jones) might appear multiple times in a directory of any size. The system is unable to differentiate which Paul Jones the user is intending to identify without further input (i.e., a unique identifying parameter such as a telephone number or email address).

Other computing systems can utilize technology similar to the aforementioned speech recognition system to match user input to an object. For example, an automated telephone directory and an auto suggest system may employ this technology. The system determines what object the user is attempting to identify by matching a small amount of user input to objects in a list. Thus, the user does not have to enter the entire name of the person to be called in the case of the automated telephone directory, or the entire address, web address, date, user name, password, etc., in the case of the auto suggest system. However, as noted above, the larger the list of objects, the more likely it is that the list includes the object intended by the user, but the match is less accurate and requires more user input. Conversely, the smaller the list is, the more accurate the match will be requiring less input, but the more likely it is that the intended object will not be in the list of objects at all.

An automated telephone directory system accepts user input in the form of touch tone telephone signals (dual tone multi-frequency) and eliminates objects from a list of objects until one object remains. These systems are often employed, for example, in larger companies. When a user calls a company, the user is asked to key in the name of an individual at the company. When the user presses the first key, names in the company directory that do not correspond to the first key are eliminated. The user presses a second key and the system eliminates from the remaining names those that do not correspond to the second key. This routine continues until one name remains, and the system selects the remaining name as the object that the user is attempting to identify, the person to be called. Alternatively, the process may continue until a sufficiently small number of possible matches remain (e.g., 10) and the system may read them out and invite the caller to identify the person to be called by voice input or key-pad entry. Existing systems do not use the list of possible matches for assisting in identifying objects to be selected by the user in a subsequent request. Thus, even though the entire name has not been entered, the system can match the user input to a name in the directory. The smaller the company directory is, the less user input that is required to find a match. For example, if there are only two names, then one key press might indicate which person is to be called. If there are several names, it may take more than one key press or some speech input before the system can determine who is to be called.

The auto suggest system in some computer software functions similarly to a DTMF system. In one system, as a user enters keystrokes into the computer system, the auto suggest feature eliminates objects from a list of previously used objects until only one remains. The auto suggest system then suggests the object to the user. The smaller the list is, the less user input it takes to match an object to the user input.

### SUMMARY

Embodiments of the invention overcome one or more deficiencies in known computing device object recognition systems by preferring objects for recognition or identification that are closely related to the user over objects that are not as closely related to the user. An embodiment of the invention further defines a method for generating a user specific file for use by an object recognition system that represents the relationship of objects to the user.

Other features will be in part apparent and in part pointed out hereinafter.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating a system for comparing user input to a first grammar and user specific file to identify an object to the user.

FIG. 2 is a block diagram illustrating a data mining program generating a user specific file from a grammar resource and a first grammar.

Corresponding reference characters indicate corresponding parts throughout the drawings.

### DETAILED DESCRIPTION

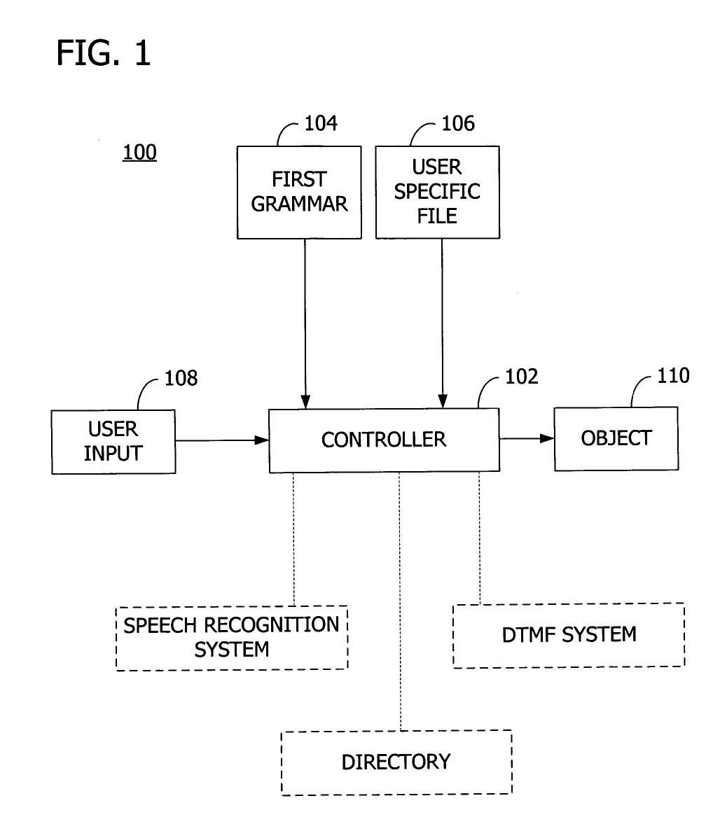

Referring to FIG. 1, one embodiment of a system for identifying an object indicated by a user is shown. The object is a computing device file or an item in a computing device file and may be the name, address, email address, phone number or other information representing a person. Embodiments of the invention provide increased accuracy in identifying the object indicated by the user by preferring objects indicated in a user specific file. In the illustrated embodiment, a system controller 102, which may be implemented in software or hardware, executes instructions to identify objects in response to user input 108 received from a user. In FIG. 1, for simplicity the controller 102 is illustrated separately from its system, such as a speech recognition system, a directory with or without auto suggest and/or a DTMF system. In fact, the controller executing the instructions may be an integral part of its system or it may be separate, as shown in FIG. 1. In response to the user input 108, the controller 102 accesses a first grammar 104 and a user specific file 106. The first grammar 104 provides a list of all objects that the user may indicate to the system 100. The user specific file 106 is personal to the user and indicates which objects are to be preferred for identification by the system 100 over other objects in the first grammar 104. The controller 102 compares the user input 108 to the information in the first grammar 104 and user specific file 106 and identifies an object 110 corresponding to the user input 108 to the user.

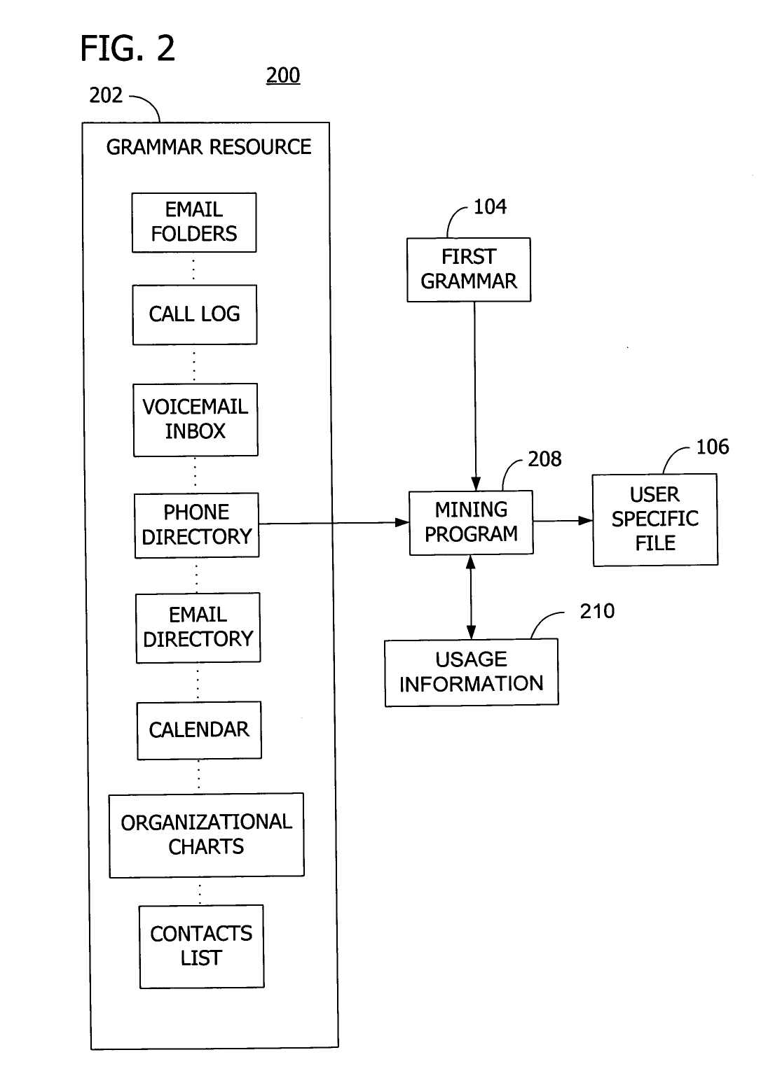

The user specific file 106 may be in any number of formats. Referring now to FIG. 2, one embodiment of a system 200 for providing the user specific file 106 for a user is shown. The grammar resource 202 has data associated with the user. Such data may include the content of the user's electronic-mail (email) inbox, email outbox, email sent items, other email folders, voicemail inbox, saved voicemail messages, telephone call logs, email directory, telephone directory, contacts list, appointments calendar, a user profile, and organizational charts, as well as advertising lists maintained by the entity operating the system 200 and/or the system 100 (see FIG. 1). The first grammar 104 is a list of objects that the user may attempt to identify to a computing device. In one embodiment, the first grammar 104 is a list of possible recipients of a communication from the user. The mining program 106 scans the grammar resource 202 for occurrences of each of the objects in the first grammar 104 and generates corresponding usage information 210. The mining program 106 may also expand the first grammar 104 based on data contained in the grammar resource 202 such as new contacts or a changed directory. It may also expand or update the object information of the first grammar 104 according to information found in the grammar resource 202. For example, if the first grammar 104 is a list of possible communications recipients, the mining program 106 may associate a nickname found in the grammar resource 202 with the appropriate person.

The usage information 210 for each object generated by the mining program 106 is determined according to one or more of a number of factors. Usage information 210 may take several forms including a ranking of the objects in the first grammar 104, and/or a value associated with each object in the first grammar 104. The rank or weight associated with each object is a function of the data in the grammar resource 202 and indicates the probability that the user will access a particular object in the future. High usage information for an object correlates to a higher probability that the user will access that object in the future, and low usage information correlates to a lower probability that the user will access that object in the future. Values or weights defined by the usage information 210 are not necessarily directly proportional to high or low usage information (e.g. they may be inversely related). For example, when the first grammar 104 is a list of possible recipients of a communication (e.g. a phone call or email) from the user, the desired effect of each occurrence of an object in the grammar resource on the usage information for that object is readily apparent. If the user has recently received an email or voicemail from a person, it is probable that the user will attempt to contact that person in the near future and the weighting or ranking of that object should be adjusted to reflect that probability. If the user has recently called or received a call from a person, it is probable that the user will do so again. If the user has a meeting in the near future with a person, it is probable that the user will send a communication to that person today. However, a meeting with a person today is more relevant than a meeting with the person tomorrow or next month and the weighting or ranking corresponding to that person should reflect that probability. The user is also more likely to communicate with someone who directly reports to the user, or to whom the user directly reports, than someone who is in a different department of an organization than the user, or higher up in the organization. These factors are merely exemplary and not intended to be an exhaustive list. By analyzing the grammar resource 202 in this way, the system 200 can determine objects of the first grammar 104 that the user is more likely to access.

The mining program 106 searches the grammar resource 202, determines the usage information 210, and generates the user specific file 208 based on the usage information 210. The user specific file 106 may take several different forms just as the usage information 210 may. For example, the user specific file 106 may be a second grammar (e.g. a list of objects wherein the list is a subset of the first grammar 104), a list of weights or values corresponding to each object of the first grammar, or a list of weights or values corresponding to a subset of the objects of the first grammar 104. The user specific file 106 may also be a series of files which together designate the objects with higher usage information. The user specific file 106 may also work in the negative by designating those objects which are to be less preferred for identification by the system 100(see FIG. 1). In one embodiment, the user specific file 208 is a list of weights associated with each object in the first grammar 104. In another embodiment, the user specific file 208 is a list of the most frequently used objects. In another embodiment, the user specific file 208 is a plurality of lists of objects wherein each list represents a group of objects with similar usage information. Regardless of the form of the user specific file 208, it designates which objects are to be preferred over other objects when a system, such as system 100, attempts to identify an object corresponding to input from the user. Thus, designated objects are preferred over undesignated objects (i.e., other objects which are not designated in the user specific file 208).

The usage information 210 determined by the mining program 208 may be structured so that it is useful for other application purposes. For example, the frequency of occurrences and source of the occurrences within the grammar resource can be used to develop an ad-hoc relationship map between people that are sending and receiving email in a messaging system. The single relationship map for a particular user can be aggregated up into a group relationship map. These relationship maps can be used in other applications such as those around social networks.

Referring back to FIG. 1, the way in which the controller 102 processes the user input 108, first grammar 104, and user specific file 106 is influenced by the format of the user specific file 106.

In one embodiment of the system 100, the user specific file 106 is a list of weights corresponding to the objects in the first grammar 104. In this embodiment, the controller 102 compares the user input 108 to the objects in the first grammar 104 to determine a probability that the user input 108 corresponds to each object. The probabilities are then modified by the weights in the user specific file 106. In one embodiment, the weights are factors and the probabilities are multiplied by the corresponding factors. In an alternative embodiment, the weights are adjustment percentages, and the probabilities are increased or decreased by the corresponding adjustment percentages. In the end, the controller 102 identifies the object with the highest probability to the user as the object 110 that corresponds to the user input 108. Alternatively, if no object has a probability above a predetermined threshold, the system 100 may ask the user for new user input 108 and repeat the process until an object 110 can be identified with sufficient accuracy.

In another embodiment of the system 100, the user specific file 106 is a subset of the objects in the first grammar 104. The controller 102 compares the user input 108 to the objects in the first grammar 104 to determine a probability that the user input 108 corresponds to each object. The controller 102 also compares the user input 108 to objects in the user specific file 106 to determine a probability that the user input 108 corresponds to each object. In the end, the controller 102 identifies the object with the highest probability as the object 110 corresponding to the user input 108. Alternatively, if no object has a probability above a predetermined threshold, the system 100 may ask the user for new user input 108 and repeat the process until an object 110 can be identified with sufficient accuracy.

In another embodiment of the system 100, the system uses a user specific file 106 that is a subset of objects in the first grammar 104, but the system 100 handles the information differently than described above. In this embodiment, speed is improved as well as accuracy. The controller 102 compares the user input 108 to the objects in the user specific file 106 and determines a probability that the user input 108 corresponds to each object. If an object has a corresponding probability that is above a predetermined threshold, then that object is identified to the user. If there is no probability above the threshold, then the system 100 compares the user input 108 to the objects of the first grammar 104. The object with the highest probability is identified as the object 110 more closely corresponding to the user input 108. Alternatively, if no object has a probability above a predetermined threshold, the system 100 may ask the user for new user input 108 and repeat the process until an object 110 can be identified with sufficient accuracy.

In yet another embodiment of the system 100, the user specific file 106 is a plurality of grammars each of which is a subset of another. For example, if the user specific file 106 contains two lists of objects, the first list is a subset of the first grammar 104, and the second list is a subset of the first list. The objects in the first list have higher usage information than those not in the first list, and the objects in the second list have higher usage information than those not in the second list. The controller 102 compares the user input 108 to the objects in the first grammar 104 and the objects in each list of the user specific file 106. The object with the highest probability is identified as the object 110 corresponding to the user input 108. Alternatively, if no object has a probability above a predetermined threshold, the system 100 may ask the user for new user input 108 and repeat the process until an object 110 can be identified with sufficient accuracy.

In another embodiment of the system 100, the user specific file 106 is a plurality of grammars, each of which is a subset of the first grammar 104. For example, if the user specific file 106 consists of two lists, the first list has the objects with usage information above a first threshold, and the second list has the objects with usage information above a second threshold but below the first threshold. The controller 102 compares the user input 108 to the objects in the first grammar 104 and determines a probability of each object. The controller 102 then increases the probabilities of the objects on the first list by a predetermined amount or factor, and increases the probabilities of the objects on the second list by a predetermined amount or factor which is less than that of the objects on the first list. The object with the highest probability is identified as the object 110 corresponding to the user input 108. Alternatively, if no object has a probability above a predetermined threshold, the system 100 may ask the user for new user input 108 and repeat the process until an object 110 can be identified with sufficient accuracy.

One skilled in the art should recognize that the controller 102 can process grammars differently without departing from the invention. One skilled in the art should also recognize that there are other sources from which to construct a grammar resource than those mentioned herein, and that a grammar resource may include any combination of those sources and the ones listed herein. One skilled in the art should also recognize that there are many ways to construct usage information and many different forms of user specific files other than as described herein.

The exemplary operating environment for the system 100 illustrated in FIG. 1 and the system 200 illustrated in FIG. 2 includes a general purpose computing device such as a computer executing computer-executable instructions. The computing device typically has at least some form of computer readable media. Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. A user may enter commands and information into the computing device through input devices or user interface selection devices such as a keyboard and a pointing device (e.g., a mouse, trackball, pen, or touch pad). Other input devices, such as a microphone, (not shown) may be connected to the computing device. A monitor or other type of display device (not shown) is also connected to the computing device. In addition to the monitor, computers often include other peripheral output devices (not shown) such as a printer and speakers, which may be connected through an output peripheral interface (not shown).

The computer may operate in a networked environment using logical connections to one or more remote computers. The remote computer may be a personal computer, a server, a router, a network PC, a peer device or other common network node, and typically includes many or all of the elements described above relative to the computer. Such networking environments are commonplace in offices, enterprise-wide computer networks, intranets, and global computer networks (e.g., the Internet).

Although described in connection with an exemplary computing system environment, embodiments of the invention are operational with numerous other general purpose or special purpose computing system environments or configurations. The computing system environment is not intended to suggest any limitation as to the scope of use or functionality of embodiments of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Embodiments of the invention may also be practiced in distributed computing environments where tasks are performed by remote processing devices that are linked through a communications network. In a distributed computing environment, program modules may be located in both local and remote computer storage media including memory storage devices.

Embodiments of the present invention are useful in a unified messaging system. A unified messaging system uses a single network of computing devices to handle all types of communications (e.g. voicemail, email, and meeting invitations) between users. A unified messaging system thus has access to a variety of grammar resources for each user (e.g. the user's email folders, voicemail folders, calendar, organizational charts, a user profile, etc.). The unified messaging system may construct a new personalized user specific file for each individual on a periodic basis. For example, if the personalized user specific file is a list of contacts for the user, the unified messaging system might rebuild the personalized user specific file nightly so that it reflects the changes made to the calendar, phone calls returned, and emails sent and received each day. A unified messaging system may employ an embodiment of the invention to enable accurate voice activated commands such as dialing, addressing an email, accessing an active directory, or addressing a meeting invitation. Embodiments of the invention are advantageous in a unified messaging system of a large company. For example, in a company with 1000 employees, there a good chance of having several employees named John Smith. If one John Smith works for Peter Jones, and one has only had infrequent contact with Peter Jones, a unified messaging system employing an embodiment of the invention is able to distinguish between the John Smith that works for Peter Jones and the one that has had minimal contact with Peter Jones, and connect Peter Jones to the John Smith that works for him when he uses voice controlled dialing, email, other means to contact the John Smith that works for him.

Embodiments of the invention are also applicable to automated directories for users connecting to an automated directory system. For example, the user may be a particular phone such as an employee's home phone. The automated directory can link the employee's home phone (e.g. though caller identification technology) and predict that the call is intended for someone who works for the employee, the employee's boss, or the employee himself (i.e. the employee's spouse or children are calling for the employee). The system may use either DTMF input or voice input from the user to determine the called party while preferring the parties listed above over the other parties available in the automated directory. In an alternative embodiment, the system may allow the person using the employee's phone to identify himself or herself to the system. The system would then use the user specific file for the identified user instead of the file associated with the employee's home phone.

Embodiments of the invention are also applicable to auto suggest features. For example, if a user connects to the same website every day at a particular time by typing the name in the address bar of a web browser, the computing device executing the web browser may predict that the user will access that site again. When the user begins typing in the address bar, the computing device may suggest the website corresponding to the typing after only a few characters are typed. By preferring the more probable website over other websites that the user has connected to, the auto suggest system can more accurately identify the object the user is trying to access with less user input that a system not utilizing personalize user specific files.

Embodiments of the invention are applicable in a number of applications. Some embodiments include personalized services from telecommunications companies. For example, a nationwide phone company can provide a voice activated dialing service. Before the present invention, directory entries were too nondescript and too numerous to lend themselves to a speech based dialing system. Matches were simply not accurate enough. For example, suppose that a nationwide phone company has 15 million telephone subscribers. If a user picked up the phone intending to call his sister and said, “Jill Adams,” a number of possible matches would be identified including Gill Adams, Jill Edems, etc., and it would take a considerable amount of time to match the speech input to each of the 15 million entries. In this example, the phone company could employ one embodiment of the present invention to construct a personalized grammar for the user by analyzing the user's call logs (e.g., incoming and outgoing calls). This would identify the particular Jill Adams that is the user's sister (and called frequently), and allow the system to differentiate between the user's sister and all of the other possible matches. Similarly, the phone company would also be able to identify other frequently called numbers such as the user's dentist, doctor, and friends. Additionally, the phone company allow the user to enter a optional user profile into the system. The optional user profile could identify the user's address, type of car, family members, clubs, sports, and/or other affiliations of the user. With some or all of this information, the phone company could enter local home maintenance businesses, car maintenance businesses, doctors, dentists, sports club phone numbers, etc. into the user specific file associated with the user. The user could then contact all of these entities through the phone company's speech dialing system.

The above example of an embodiment of the invention could also be a revenue and advertising source for the phone company. Specifically, businesses could pay for the right to be identified in a number of user specific files. For example, the phone company knows a user has a particular make or model of automobile. If the user picks up the phone and says, “car maintenance,” then the phone company can offer the user the nearest dealer for the make or model and at least one dealer who has paid for the privilege to be added. Similarly, if the user said, “pizza delivery,” then the system would identify the nearest pizza delivery business and a pizza delivery business that paid to be included. The second time the user inputs “car maintenance,” or, “pizza delivery” to the system, the system should identify the business selected the first time the user input “car maintenance,” or, “pizza delivery.” Alternatively, the only businesses listed may be those that pay the phone company for the right to be identified.

Another embodiment of the invention may also be advantageously employed. The system may allow the user to identify himself or herself to the system so that the system may load the user specific file associated with that user. This feature is important in the phone company example because it allows a user to utilize his voice dialing service from a phone other than his or her own. For example, if a user's car breaks down at a friend's house, and the friend owns a different type of car, the user will want to find the nearest shop for his car. When the user picks up the friend's phone and says, “car maintenance,” the system will direct the user to the nearest shop servicing the friend's make of car and a shop who has paid to be advertised. If, however, the system allows the user to identify himself to the system (e.g., enter his home phone number or personal code), then the system can suggest the nearest shop for the user's make of car.

Another example of the applicability of embodiments of the invention can be seen with Internet phone services. Before the invention, such phone services would connect a user to other subscribers with whom the user has a mutually declared interest and advanced knowledge (i.e., a friend to friend configuration). Employing embodiments of the present invention, the Internet phone service can be intermediate between consumers and local companies. As in the phone company example above, suppose a user accesses the Internet phone service to call for pizza delivery. The Internet phone service would identify a pizza delivery business paying for advertising with the Internet phone service, and connect the user. Application of embodiments of the invention to Internet phone service can thus provide a revenue stream for Internet phone service companies, allow Internet phone service other than in a friend to friend configuration, and may result in the proliferation of Internet phone service in general.

Having described the invention in detail, it will be apparent that modifications and variations are possible without departing from the scope of the invention defined in the appended claims.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the various embodiments of the invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A system for identifying an object corresponding to user input from a user, said system comprising:
a first grammar having a list of objects;
a user specific file designating a subset of the list of objects of the first grammar wherein the subset is related to the user;
a controller receiving user input and comparing the user input to the subset of objects of the first grammar and giving preference to the objects of the user specific file which correspond to the user input over objects of the first grammar which correspond to the user input wherein the controller identifies the object corresponding to the user input.

2. The system of claim 1 wherein the controller compares the user input to the objects in the first grammar to determine a probability that the user input corresponds to each object, increases or decreases the probability that the user input corresponds to each object according to any weighting for any object in the user specific file, and identifies the object with the highest probability as the object corresponding to the user input.

3. The system of claim 1 wherein the controller compares the user input to the objects in the first grammar to determine a probability that the user input corresponds to each object, compares the user input to objects in the user specific file to determine a probability that the user input corresponds to each object, and identifies the object with the highest probability as the object corresponding to the user input.

4. The system of claim 1 further comprising a plurality of grammars wherein each grammar is a subset of another and preference is given to the objects in each smaller grammar.

5. The system of claim 1 wherein the user specific file is a plurality of grammars wherein each of the plurality of grammars represents a varying degree of preference for the objects therein.

6. The system of claim 1 wherein the controller compares the user input to objects in the user specific file to determine a probability that the user input corresponds to each object, compares the user input to objects in the first grammar if a probability from comparing the user input to objects of the user specific file is not above a threshold, and identifies the object with the highest probability as the object corresponding to the user input.

7. The system of claim 1 wherein each of said objects comprises the name of a person and their associated nicknames.

8. The system of claim 1 wherein the system advertises at least one particular object by designating the particular object in the user specific file.

9. The system of claim 1 wherein the user specific file designates a first object as preferred for identification and wherein when the user input corresponds to both the first object and a second object, the controller identifies the first object to the user.

10. A user specific file for use by a user wherein the user specific file is based on a grammar resource including at least one of inboxes, electronic mail folders, directories, contacts list, calendars, organizational charts, advertising lists, user profile, and call logs, said user specific file comprising:
a list of objects selected from the grammar resource wherein the objects are selected based on a relationship of the object to the user; and
a weight associated with each object in the list as a function of the relationship of the object to the user.

11. The user specific file of claim 10 wherein the relationship of the object to the user is at least partially determined by at least one of:
how recently the object appears in the grammar resource;
the number of occurrences of the object in the grammar resource; and
what type of grammar resource the object occurs in.

12. The user specific file of claim 10 wherein each of said objects comprises the name of a person and their associated nicknames.

13. The user specific file of claim 10 wherein the list of objects selected from the grammar resource includes at least one object from an advertising list and the weight associated with the object from an advertising list is determined at least partially based on the advertising list.

14. A method of designating a file specific to a user based on a grammar resource including at least one of inboxes, electronic mail folders, directories, calendars, contacts list, organizational charts, advertising lists, user profile, and call logs of the user, wherein objects designated in said user specific file are given preference over other objects when determining an object corresponding to input from the user, said method comprising:
gathering statistics of usage by the user of objects in the grammar resource;
designating the objects having higher usage by the user based on the gathered usage information wherein the designated objects are given preference over undesignated objects when determining an object corresponding to input from the user.

15. The method of claim 14 wherein said gathering comprises:
searching the grammar resource for objects;
counting the occurrences of each object in each type of grammar resource; and determining how recently the object occurred in the grammar resource.

16. The method of claim 14 wherein each of said objects comprises the name of a person and their associated nicknames.

17. The method of claim 14 wherein designating the objects having higher usage by the user comprises assigning a value to each object wherein the value represents a stronger preference for an object having higher usage information and a weaker preference for an object having lower usage information when determining an object corresponding to input from the user.

18. The method of claim 14 wherein designating the objects having higher usage by the user comprises sorting objects into bins according to similar usage information wherein bins having objects with higher usage information are preferred more than bins with lower usage information when determining an object corresponding to input from the user.

19. The method of claim 14 further comprising designating objects based on an advertising list wherein the designated objects are given preference over undesignated objects when determining an object corresponding to input from the user.

20. The method of claim 14 further comprising designating objects based on a user profile wherein the designated objects are given preference over undesignated objects when determining an object corresponding to input from the user.
